(19) United States
(12) Patent Application Publication
(10) Pub. No.: US 2003/0123519 A1
(43) Pub. Date: Jul. 3, 2003

(54) Device for monitoring a predetermined temperature

(76) Inventor: Uriel Bachrach, Jerusalem (IL)

Correspondence Address: BIRCH STEWART KOLASCH & BIRCH, PO BOX 747, FALLS CHURCH, VA, 22040-0747, US

(21) Appl. No.: 10/317,138

(22) Filed: Dec. 12, 2002

Related U.S. Application Data
(60) Provisional application No. 60/340,866, filed on Dec. 19, 2001.

(51) Int. Cl. G01K 11/00

(52) U.S. Cl. 374/159

(57) ABSTRACT

The present invention concerns a device for monitoring the temperature of items such as food products, blood products, tissue cells etc. This device comprises a medium that changes its physical state from one phase to a second phase, for example, from solid to liquid, at a critical temperature. These changes in phases cause an irreversible change in a detectable parameter, which permits the detection of a change in the temperature during the handling of the monitored item.

### FIELD OF THE INVENTION

This invention relates to a device for monitoring temperature.

### BACKGROUND OF THE INVENTION

A number of products, such as food products, finished solutions of pharmaceuticals, vaccines, blood products, chemical products, tissue cells, etc., can be damaged upon changes of the temperature in which they are being handled, transported and/or stored.

There are several known methods that are used to monitor the temperature of certain products.

U.S. Pat. No. 2,261,473 describes the use of certain organic or inorganic substances that change their acid-base character upon melting or solidification as a result of their intramolecular rearrangement. These changes can influence the color of pH indicators, which change reversibly from acid to base color, or vice versa.

WO 99/64832 describes a composition containing two components, which together show an elevated freezing point and bring about a color change at selected temperatures. These compositions may be filled into a transparent container to form together a temperature indicating device.

FR 2529669 relates to an indicator for indicating whether a critical temperature was exceeded. This indicator comprises a sealed enclosure defining two separate compartments which communicate with each other via a zone of small cross-section, the enclosure enclosing a liquid or a mixture of liquids that freeze at a critical temperature.

The quality of products may be adversely affected if during handling or storage the temperature changes for a period of time to be above a certain critical level. In order to be able to monitor proper handling of such products, it is important to be able to have an indication whether such an event occurred. Simply affordable means to afford that are thus desired.

### SUMMARY OF THE INVENTION

It is an object of the present invention to provide a device that can provide an indication if at one point during handling or storage, temperature of the product to which it is attached exceeded a certain critical temperature. The term “critical temperature” will be used to denote the maximal temperature permitted for a product during handling or storage.

In accordance with the invention, a device is provided that has a noticeable feature that changes irreversibly when the device's temperature rises above the critical temperature. Thus, in accordance with the invention the device is attached to or fixed to a product, the temperature of which is to be monitored, and a change in the noticeable feature then indicates improper storage or handling, namely, that during such storage or handling the temperature exceeded above the critical temperature.

In accordance with the first aspect of the invention there is provided a device that comprises a medium which changes its physical state from one phase to a second phase at a critical temperature. An example is a change from solid to liquid or to gas, from liquid to gas, from a gel form to a liquid, etc. The change in phase causes a change in a detectable parameter, which changes irreversibly.

In accordance with one embodiment of the invention, embedded in the medium is at least one physical element that can change its position upon change of the medium from a first phase to a second phase, when the detectable parameter is the position of said at least one physical element.

In accordance with one preferred embodiment of the invention, embedded in the medium are a plurality of elements that form together a visible form. The elements can change their position upon the changes of the medium from a first phase to a second phase. The detectable parameter is then the integrity of the visible form.

By one example, the elements are located at one end of the device and a member to which they are drawn is located at another end of the device. Said member may be magnetic while the elements may be made of metal or the elements may be magnetic and the member may be made of metal. As long as the medium is in a solid form, the two remain separate. Once the temperature rises above the critical temperature, the phase of the medium changes and the elements can move towards said member.

In another preferred embodiment, the element is a member that expands or shrinks by virtue of its elastic properties upon changes of the medium from a first phase to a second phase. The detectable parameter is the expansion of said element from its original pressured position. By a specific example, the expandable element is a spring that is stretched or stressed at one end of the device. Once the temperature rises above the critical temperature, the phase of the medium changes and the spring can return to its resting, flexed state. By another example, the element is a sponge that is pressed against one end of the device. Where the temperature rises above the critical temperature, the phase of the medium changes and is then fully or partially absorbed by the sponge, which in turn expands in the device.

In accordance with another embodiment, provided are at least two media, each having a different color, separate from one another, so they together form a visible pattern. As the temperature rises, the two media mix and a specific color pattern changes or disappears. In one preferred embodiment one of the at least two media, is encapsulated by a soluble capsule which is positioned in the second of the at least two media. As the temperature rises above the critical temperature, the phase of the media changes, the soluble capsule dissolves and the two media mix causing a color change.

In another preferred embodiment, the soluble capsule contains a medium capable of dissolving the capsule upon change in phase. The capsule is placed in a transparent medium, which does not undergo a phase change and which does not cause dissolution of the capsule. The transparent medium may be in the form of a gas, e.g. air, oxygen, inert gases or mixtures thereof, in the form of a liquid or low-pressure gaseous medium. As the temperature rises above critical temperature, the medium contained within the capsule changes phase, the capsule dissolves and the medium mixes with the transparent medium. The visual parameter may be a color change ensued as a result of the mixture or the spillage of the medium previously contained within the capsule into the transparent medium.

In a specific embodiment, the capsule further contains a sponge, which is colored. Once the temperature rises above the critical temperature, the phase of the surrounding media changes, the capsule dissolves and the sponge absorbs the media affecting a color change.

In accordance with another embodiment, provided are at least two media, of identical color, which are separate from one another. The two media are such that upon mixing there is a chemical reaction that yields a color change. As the temperature rises above the critical temperature, the two media mix with a resulting color change. By one example, one media is encapsulated by a soluble capsule, which is placed in the second media. Both media may be transparent. As the temperature rises above the critical temperature, the surrounding media changes phase and dissolves the soluble capsule. When the two media are mixed, the color changes and the combined media becomes opaque.

The term “capsule” used herein refers to any small receptacle enclosed within the device and which encloses a medium. The capsule may be in a variety of shapes and forms and is fabricated from a material capable of releasing the content of the capsule upon change in temperature. Such materials may be thin glass or consumable substances, such as but not limiting to polysaccharides, e.g. gelatin. In case of a glass capsule, the walls may include a crack or other opening to facilitate media exchange between the interior and the exterior of the capsule.

In accordance with another embodiment of the invention, included in the medium is a substance that has a certain intrinsic visual parameter that changes irreversibly upon change of the medium from said first phase to a second phase. An example for such an intrinsic visual parameter is fluorescence light irradiation. As a result of change from the first phase to the second phase a substance embedded in the medium can start to fluoresce and the fluorescent signal may then serve an indication for rise in temperature above the critical temperature. By another example, the medium may comprise fluorescent substances and the substances that quench the fluorescence light and as a result in the phase change, the two come close to one another and the fluorescence, which existed in the product, will then disappear.

In accordance with another embodiment, the device includes several compartments, each with a different medium, each of which has a different critical temperature. Based on the change in a particular parameter in each of the compartments, the device can be used more exactly to pinpoint the temperature range to which the product was exposed during handling.

In accordance with a specific embodiment, a metallic element is positioned at one end of the device, separated from a magnetic element positioned at the other end of the device by a plurality of compartments. Each of said compartments contains a different medium having a different critical temperature. The plurality of chambers is arranged in ascending order, with the lowest of the critical-temperature media being close to the metallic element. As the temperature of the device rises each media changes phase causing movement of the metallic object towards the magnet.

The invention also provides, by another of its aspects, a method for preparing a device of the kind described above. The method comprises providing a medium that changes its physical state from one phase to a second phase at a critical temperature; and embedding at least one element with a detectable feature in the medium, said detectable feature changes at least one property upon change of the temperature of the medium above said critical temperature.

In accordance with yet another embodiment of the present invention, a device is provided that is constructed from two independent chambers, each containing a medium of a different color. The two chambers are engaged to one another at said one end which is being sealed with a piercable septum. At least one of the chambers further contains a hollow open-ended needle, which is capable of piercing through the septum once the two said one end of said chambers are engaged with one another. The two chambers are attached to each other head-to-head, e.g. by rotating the chamber containing the needle in such a way that it penetrates the septa of both chambers. The needle now provides a passage between the two chambers together and allows movement of medium from one chamber to another upon change in phase. As the temperature exceeds critical temperature, the media in each of the chambers undergoes a phase change and mix to affect a color change.

In accordance with another aspect of the invention there is provided a method for detecting a rise in the temperature of a product above one or more defined critical temperature, comprising:

providing a device of the kind defined above;

attaching for embedding the device in said product; and

monitoring whether a change in said detectable parameter occurred in the device.

### BRIEF DESCRIPTION OF THE DRAWINGS

In order to understand the invention and to see how it may be carried out in practice, a preferred embodiment will now be described, by way of the above non-limiting examples, with reference to the following drawings:

FIG. 1 shows a device in accordance with an embodiment of the invention, fixed onto a food item (a frozen chicken in this example) which has three compartments, each one changing its phase from a solid to another phase at a different critical temperature (left) In this example the critical temperatures are −20° C., 0° C. and +4° C.; Upon rise in temperature (right) the order is disrupted and the pattern of numbers disappears. Based on which number disappears and those which are still present, the maximal temperature range reached by the food item during handling can be monitored.

FIG. 2 shows another embodiment in which the device which is made from two different media, each having a different color with an air-gap (G) between them. In a frozen state, two colors are visible (left side). Once a temperature rises above the critical temperature (the temperature may be slightly different for the two media, as also described in Example 4, which is of advantage in the preparation of the device) the two media will mix with one another and the two-colored patterns (left) disappear (right).

FIG. 3A shows a device 300 according to another embodiment of the invention, including a magnet 302 at one end and metal beads 304 at the other end. The device is filled with a medium 306. As long as the temperature is below the critical temperature (left) the beads remain at said other end. Once the temperature rises above the critical temperature, the medium 306 changes in phase which permits the beads to move towards the magnet (right). FIG. 3B shows the device 300, which includes only one metal element 304.

FIG. 4 shows a device 307 according to another embodiment of the invention, in which there is a plurality of chambers 308. In each chamber there is a medium of different critical temperature, labeled accordingly. As long as the temperature is below the initial temperature of the medium of the lowest critical temperature, all the media remain at a said phase. As the temperature rises, the media in the chambers 308 undergoes a phase change when its respective critical temperature has exceeded. For example if the temperature rises above −30° but doesn't yet reach −20°, the media in the chambers labeled as −50, −40, and −30 will change phase while the chambers labeled as −20, −10 and −5 will remain unchanged (stage A). Said change in phase may result in a simultaneous change in the predetermined shape of the media. If the temperature rises to room temperature the media in all the chambers will change phase, as shown in stage B.

FIGS. 5A-5B show a device 309 according to another embodiment of the invention, in which a spring 310 (FIG. 5a) or a sponge 311 (FIG. 5b) is positioned in a stressed state in one end of the device 309. The device is filled with a medium 312 and as long as the temperature is below the critical temperature of the medium the spring 310 or sponge 311 remains stressed. As the temperature rises above the critical temperature of the medium, the spring or sponge expands and indicates rise above critical temperature.

FIGS. 6A-6C show a device 313 according to another embodiment of the invention, in which a capsule 314 containing one medium 315 is placed in another medium 316. The capsule 314 may be made of a soluble substance which dissolves in the said another media 316 at temperatures higher than the critical temperature or the capsule may be made of a thin glass that breaks when its content liquid is frozen, thus releasing its content when reaching above critical temperature. FIG. 6A shows a device 313 wherein the capsule 314 contains a medium 315 of the same color of the second medium 316. When the capsule dissolves upon increase in the temperature, the two media mix resulting in a color change. FIG. 6B shows a device 313 wherein the capsule 314 contains a medium 317 having a different color than the surrounding medium. Upon mixing, the color of the mixture changes. FIG. 6C shows a device 313 wherein the capsule 314 further contains a colored sponge 318. Once the temperature rises above the critical temperature, the phase of the surrounding changes, the capsule dissolves and the sponge absorbs the surrounding medium, resulting in a color change.

FIG. 7 shows a device 319 according to another embodiment of the invention, in which a predetermined pattern such as a letter combination or a symbol is visible. The pattern is made of a medium, which dissolves at the surrounding medium when the temperature of the surrounding media exceeds the critical temperature. When the temperature rises above the critical temperature, the medium changes phase, thus dissolving the pattern. Once the predetermined pattern dissolves, a different pattern, which is printed at the bottom of the device 319, becomes visible. The printed pattern may be a letter combination or a symbol indicative of the change in temperature.

FIG. 8 show a device 320 according to yet another embodiment of the invention, in which a transparent container contains two frozen mediums 321 and 322, 323 and 324, respectively, of different color but of similar critical temperatures. The mixing of both media results in a medium of a different color. When the temperature rises above the critical temperature of both media, the media 323 and 324 change phase and mix thus yielding the medium of a different color. The media 323 and 324 may be of any geometrical structure. Two possible embodiments are shown in FIGS. 8A and 8B.

FIG. 9 shows a device 325 according to another embodiment of the invention, in which a metallic element 326 is positioned at one end of the device, separated from a magnetic element 327 positioned at the other end of the device by a plurality of chambers 328. Each of the chambers contains a different medium having a different critical temperature. The plurality of chambers are arranged in ascending order, with the lowest of the critical-temperature media being close to the metal element 326. When the temperature of the device rises, each medium changes phase in accordance with the increase in the temperature, causing movement of the metal element 326 towards the magnet 327. The detectable parameter is the position of the magnetic element 326.

FIG. 10 shows a device 329 according to another embodiment of the invention. Device 329 is constructed from two separate chambers 330 and 331, each containing a medium of a different color. Each chamber has a head-end 332 and 333 and a tail-end 334 and 335, respectively. The head ends 332 and 333, contain each a septum. The septum of head-end 333 further contains hollow open-ended needle 336 capable of piercing a hole through the septum once the head-end 333 is rotated, thereby advancing needle 336 through the septum. The two chambers 330 and 329 are attached to each other head-to-head as shown and by rotating the head-end 333 the needle 336 advances and it penetrates the septa of both chambers 330 and 331. The needle 336 now connects the two chambers and allows movement of media from one chamber to another upon change in phase. As the temperature exceeds critical temperature, the media in both chambers, now connected through needle 336, change phase and mix to affect a color change.

### EXAMPLES

### Example 1

Blue stained metal beads are placed in a container filled with an aqueous solution. Next the beads are arranged by a magnetic template to form a predetermined pattern, such as a number or a letter combination, i.e., “O.K”. The aqueous solution is next frozen and the container is removed from the template and attached to the frozen item or merchandise, which should be handled below the freezing point of the aqueous solution (0° C., for example).

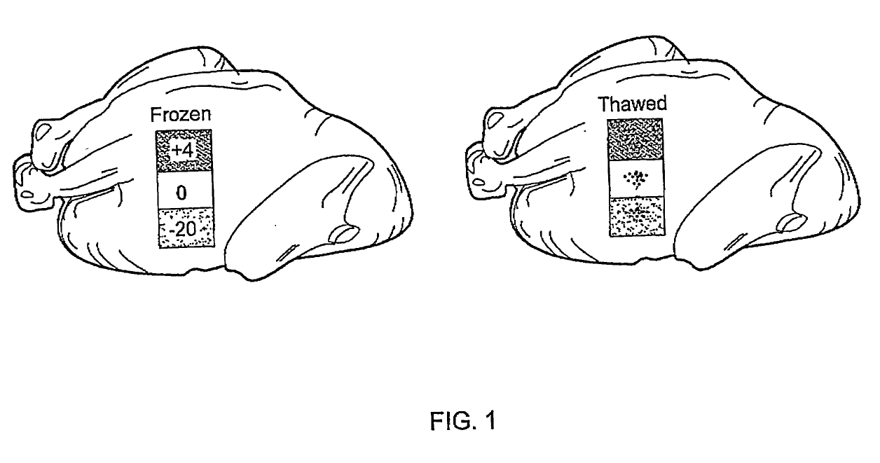

When reaching a temperature above the freezing point, the aqueous solution in the container is thawed, leading to the disruption of the beads pattern (FIG. 1). The container should be placed on the merchandise in a way ensuring the movement of the beads when the supporting matrix melts. This can be a spontaneous movement or aided by a magnet or by any other force.

This device permits the easy detection of changes of temperature during handling or shipment, which may affect the properties of the merchandise/item.

### Example 2

The solution of example 1 can be modified by mixing different alcohols of different concentrations, to achieve a desired freezing point, as shown in Tables 1-3.

TABLE 1
1. Freezing Point of Glycerol-Water Solutions

| Glycerol, % w/w | Freezing Point ° C. |
|---|---|
| 10 | −1.6 |
| 20 | −4.8 |
| 30 | −9.5 |
| 40 | −15.4 |
| 50 | −23.0 |
| 60 | −34.7 |

TABLE 2
1. Freezing Point of Denatured Alcohol-Water Solutions

| Denatured Alcohol, % V/V | Freezing Point ° C. |
|---|---|
| 5 | −2.8 |
| 10 | −4.0 |
| 15 | −6.0 |
| 20 | −8.5 |
| 25 | −11.5 |
| 30 | −14.8 |
| 35 | −18.3 |
| 40 | −22.1 |
| 45 | −26.9 |
| 50 | −31.1 |
| Alcohol Anhyclrous | −130 |

TABLE 3
1. Freezing Point Methanol-Water Solutions

| Methanol, % V/V | Freezing Point ° C. |
|---|---|
| 10 | −5 |
| 20 | −12 |
| 30 | −21 |
| 40 | −33 |
| 50 | −47 |
| 60 | −57 |
| Absolute | −97 |

Dry ice sublimes at −78.5° C.

Oleic acid freezes below +4° C.

### Example 3

An aqueous solution of 10% sodium chloride (or other) is frozen in a mold at −10° C. The mold creates a groove in a pre-determined pattern (like the letters OK) in the frozen fluid. The groove is next filled with a chilled visible marker. If the temperature of the environment raises to −6° C., the pattern of the visible marker is disturbed.

### Example 4

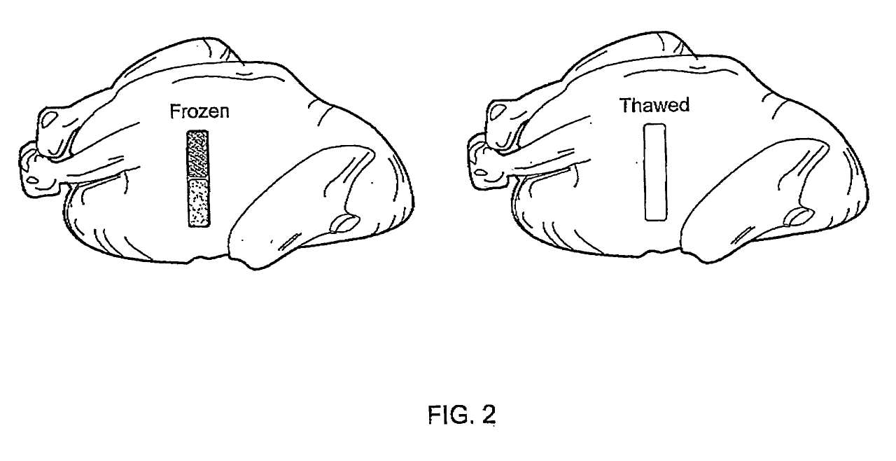

A colored solution (solution A) is inserted into a transparent container or capsule and then frozen. After inverting the container, a chilled second fluid (solution B), having a slightly lower freezing point is added, and frozen. A small inter-space of air separates between the two layers. If the temperature of the environment raises above the freezing point of both solutions, solution A will change position or color to give a visible and irreversible change (FIG. 2).

### Example 5

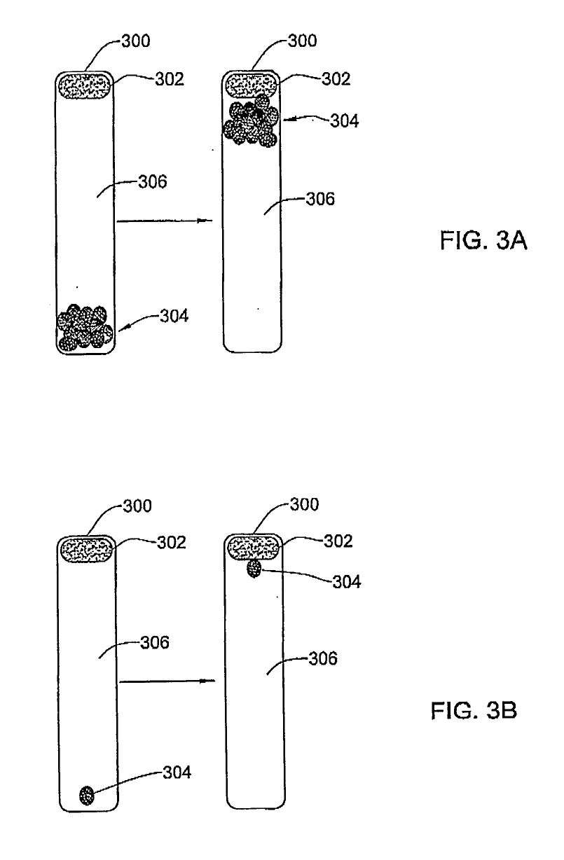

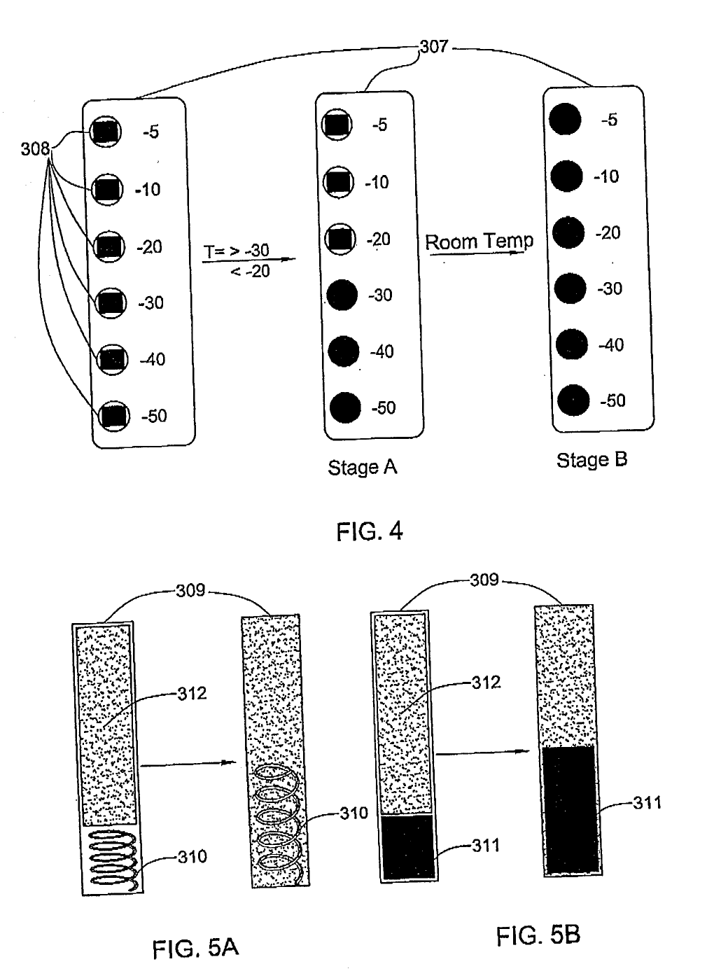

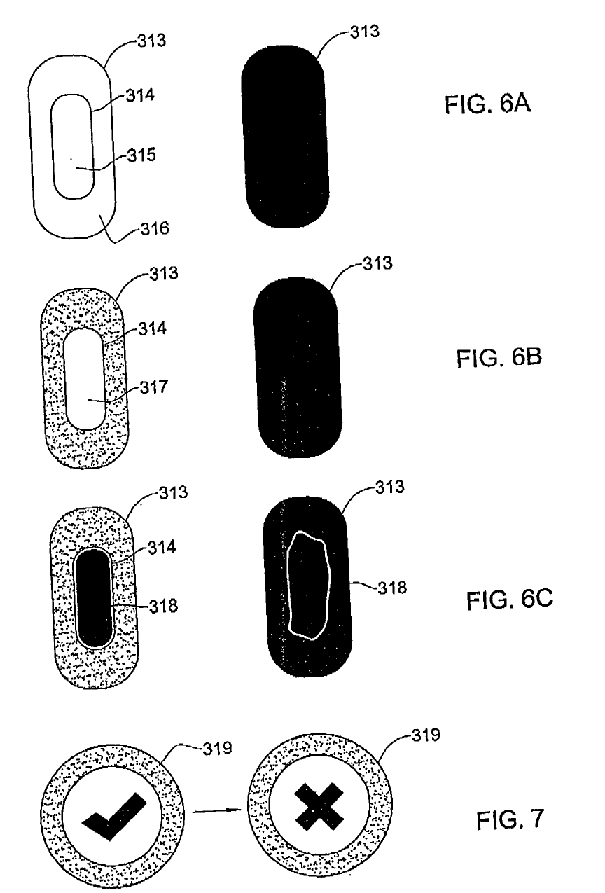

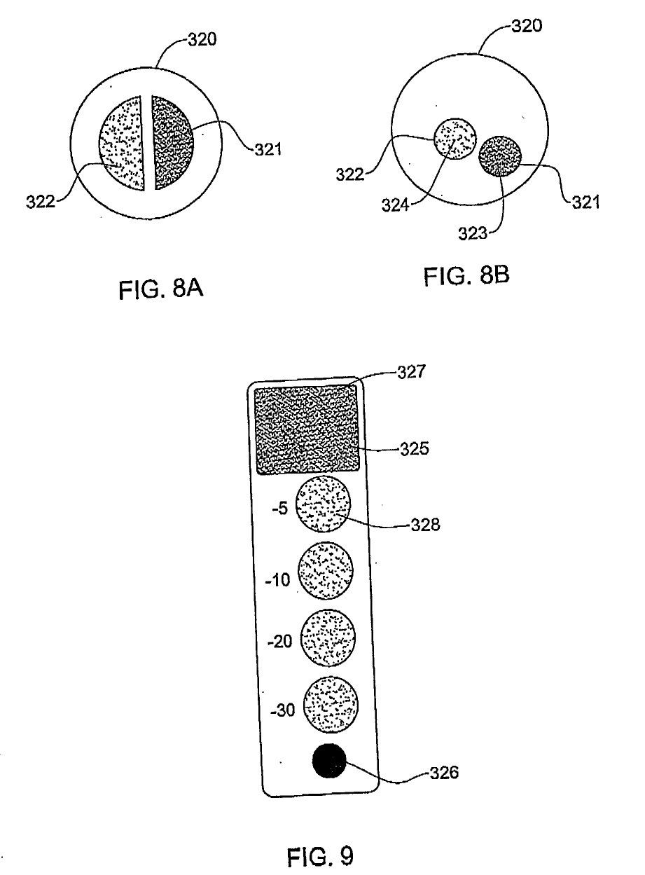

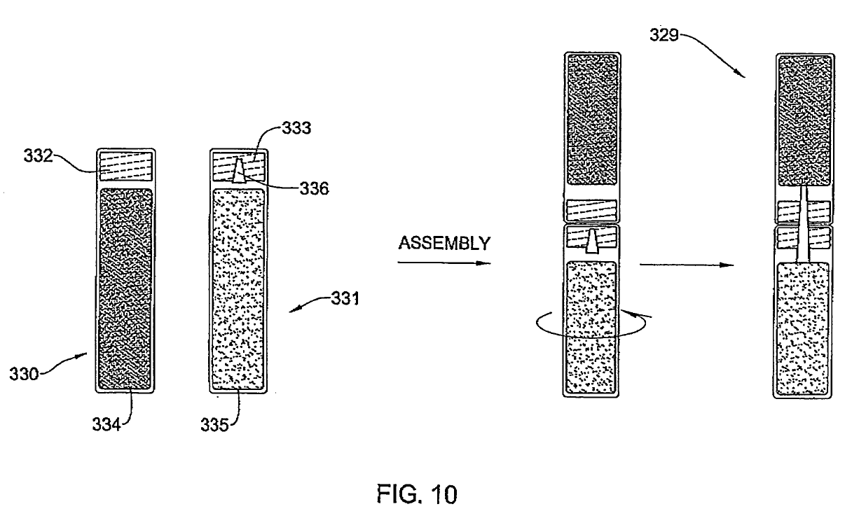

Metal beads are placed and allowed to settle in a container containing a supporting matrix with a desired melting temperature. The matrix is frozen. A magnet is placed in the container opposite to the beads (FIG. 3). The container is attached to the merchandise as in Example 1 above. When the matrix thaws, the metal beads cross it and attach the magnet.

One can know that the item to which said container was attached reaches a higher temperature than the desired one, by noting that the metal beads are attached to the magnet.

### Example 6

A spring is placed in a container and is mechanically pressed down by a frozen matrix with melting temperature. The container is attached to the merchandise as in Example 1 above. When the matrix thaws, the spring is relieved and occupies the volume of the container.

### Example 7

Thaw indicators are used to monitor proper treatment of food, chemicals, bio-chemicals, pharmaceuticals, bio-materials (including human and non-human cells and cell lines, body fluids and/or organs) that should be kept or shipped or handled at a low temperature (4° C. to −130° C. as required).

1. A device that comprises a medium that changes its physical state from one phase to a second phase at a critical temperature, wherein these changes in phases cause a change in a detectable parameter and wherein said change being irreversible.

2. A device according to claim 1, wherein the change of phases is from solid to liquid.

3. A device according to claim 1, wherein the change of phase is from a gel to a liquid.

4. A device according to claim 1, wherein the change of phases is from solid to gas.

5. A device according to any one of claims 1-4, wherein embedded in said medium is at least one visible element that can change its position upon changes of the medium from a first phase to a second phase, said detectable parameter is the position of said at least one visible element.

6. A device according to any one of claims 1-5, wherein embedded in said medium are a plurality of elements forming together a visible form, said elements can change their position upon changes of the medium from a first phase to a second phase, said detectable parameter is the integrity of said visible form.

7. A device according to claim 6, wherein said elements are metal beads.

8. A device according to claim 5, wherein said at least one visible element is a metallic element located at one end of the device and a member to which it is drawn is magnetic, located at another end of the device.

9. A device according to claim 5, wherein said at least one visible element is a member that expends upon changes of the medium from a first phase to a second phase, said detectable parameter is the expansion position of said at least one visible element.

10. A device according to claim 9, wherein said member is a spring.

11. A device according to claim 9, wherein said member is a sponge.

12. A device according to claims 1-4, wherein said medium comprises a substance of which at least one visible parameter changes irreversibly when the medium changes from the first phase to a second phase.

13. A device according to any one of claims 1-6, having several compartments, each with a medium with a different critical temperature.

14. A device according to claim 13, wherein one of said compartments is a capsule containing one medium with one critical temperature, said capsule is placed within a second medium.

15. A device according to claim 14, wherein said one medium is a substance capable of solubilizing said capsule and wherein second medium is a substance incapable of solubilizing said capsule.

16. A device according to claim 15, wherein said second medium is a gas or a liquid.

17. A device according to claim 16, wherein said second medium is colored.

18. A device according to claim 14, wherein said capsule is solubilized in said second medium at a temperature exceeding critical temperature.

19. A device according to any one of claims 14-18, wherein one certain medium and said second medium are of the same color, and upon mixture of the two media a color change occurs.

20. A device according to any one of claims 14-18, wherein said one medium and said another medium are of a different color.

21. A device according to claim 14, wherein said capsule further contains a sponge.

22. A device according to claim 13, having two compartments separated from each other, each holding a medium with a different color than the other, said detectable parameter is a change in a color upon mixture of the two media.

23. A device according to claim 22, wherein one or both of said media of a different colors includes a substance that has a certain intrinsic visual parameter that changes irreversibly upon change of the medium from said first phase to a second phase.

24. A device according to claim 23, wherein said intrinsic visual parameter is fluorescence light irradiation.

25. A device according to claim 23, wherein said intrinsic visual parameter is a substance that quenches the fluorescence light which existed in the product prior to the change of the medium from said first phase to a second phase.

26. A device according to any one of claims 14-25, wherein said capsule is made of a thin glass or consumable substance.

27. A device according to claim 26, wherein said thin glass capsule has an opening.

28. A device according to claim 26, wherein said consumable substance is a polysaccharide.

29. A device according to claim 22, having two independent chambers engaged to one another at one end thereof, each of said one end being sealed with a piercable septum, one of said chambers has a hollow open-ended needle that once the two said one end of the chambers are engaged to one another, said needle pierces the two septa thereby providing a passage therebetween.

30. A device according to claim 29, wherein said piercing is achieved through rotating one of said chambers.

31. A method for monitoring that a product's temperature did not rise above a certain critical temperature comprising:
(1) providing a device according to any one of claims 1-22;
(2) detecting whether a change in the visible parameter has occurred.

32. A method for preparing a device according to any one of claims 1-22 comprising:
(1) providing a medium that changes its physical state from one phase to a second phase at a predetermined temperature;
(2) embedding in said medium at least one detectable element, the detectable feature thereof changes upon changes of the medium from a first phase to a second phase.
